(19) United States
(12) Patent Application Publication
(10) Pub. No.: US 2013/0223675 A1
(43) Pub. Date: Aug. 29, 2013

(54) Key Identification Device and Method of Use

(71) Applicant: Carter Belrose, Duluth, MN (US)

(72) Inventor: Carter Belrose, Duluth, MN (US)

(21) Appl. No.: 13/778,508

(22) Filed: Feb. 27, 2013

Related U.S. Application Data
(60) Provisional application No. 61/603,741, filed on Feb. 27, 2012.

(51) Int. Cl. G06F 17/30

(52) U.S. Cl. CPC G06F 17/30244
USPC 382/100

(57) ABSTRACT

A key identification device is disclosed. This device will read and store the unique properties of a key and allow a user to associate a name with these unique properties. A user can then retrieve this name by later inserting the key into the device.

### CROSS REFERENCE TO RELATED APPLICATIONS

This application claims the benefit of provisional patent application Ser. No. 61/603,741 filed 2012 Feb. 27 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a key identification tool. Specifically a device and an application are disclosed that store a unique key identifier with an assigned name. At any given time, an individual or business may have several keys to secure both real and personal properties. These keys may be for doors, locks, safes, outbuildings, storage units, homes, vehicles, or other similar items and locations. Often this multitude of keys is stored on a key ring or in a safe location. Often these keys all appear to be similar. Additionally, the use of any given key may vary dependent upon the season or the time. Therefore, it is difficult to remember what each key is used for.

Currently, to solve the problem of not knowing the correct identification of the appropriate key, a user is required to try each of their several keys until a correct match is found. This process of trial and error can be extremely time consuming and difficult. This problem is only exacerbated when the individual has several keys and several locks requiring keys. Therefore, a solution is needed to easily identify the proper key for a lock. Ideally, this solution allows a user to quickly input identification data associated with the key and to store this data electronically on a standalone device or on an existing device such as a smart phone or computer.

### SUMMARY OF THE INVENTION

The present invention provides a device and software application that stores and identifies the unique identifiers of a key for later retrieval. This device can be a standalone device, utilizing an existing device such as a smart phone or tablet, or connected to an existing device such as a smart phone, tablet, or computer. The device includes a means of acquiring the unique bittings of the key and allows the user to identify the key associated with these unique bittings. This identification is then stored in the device memory or within the memory of an additional device hosting software for the key identification. This stored information can then be retrieved to identify the key at a later time. Accordingly, a user can insert a key into the device where the device will display the name of key based upon the earlier stored image of the same key.

Several alternative embodiments of the device and system are disclosed. In the first embodiment the device is standalone device. This device includes a display screen, a keypad, a key receipt aperture, a memory storage component, a processor, a power source, and electrical circuitry to operate and control the device. To use this device a user will insert a key into the key receipt aperture. If the key has not yet been assigned a name, the user will indentify the key. This is done by the user uniquely indentifying the key with a name and typing this name into the device using the keypad. The display screen will display the typed name. The device will then read the bittings of the key and store the profile of the bittings with the unique name of the key. The bittings may be analyzed by any means that will allow an accurate reading of the individual characteristics of the key. This means may be a scanned image, a physical touching of the bittings and recording the profile, a photo, a light source generating a shadow that is then recorded, or any other similar means now known or hereafter known. After a key is identified, later insertion of the key into the device will result in the display of the previously entered key name on the display screen of the device.

In the second embodiment of the present invention, an application is installed onto a smart phone or tablet device. This application will use the existing electronics of the smart phone or tablet to read the key bittings and associate the unique key bittings with a user entered name. Accordingly, a user will place the key flat on the touch screen of the smart phone or tablet device. The smart phone or tablet will analyze the image of the key with a particular emphasis on the unique bittings and shape of the key. This image will then be stored. The user will then associate a name with this image which is also stored. For later identification, a key that has been previously imaged will display the name associated with the image.

In a third embodiment of the present invention, the key is placed into a USB style device that is then inserted into a computer with a USB port or other similar device with a USB port. The USB device will include a means to measure or image the unique bittings of the inserted key. The computer or device will include software to capture the unique image of the key bittings. This image will then be stored. The user will then associate the stored image of the key with a name. This name can then be retrieved when the key is re-inserted into the device and recognized by the software.

In a fourth embodiment of the present invention, the key is inserted into an external key identification device that is attached to a smart phone. This external key identification device will communicate with the smart phone or other similar device through an accessory port. This external key identification device may be configured to work with several popular styles of smart phones and tablets. These smart phones or tablets will contain an application to control the external key identification device and allow an image of the key to be stored on the device and associated with a unique name for the key. In use, a user will attach the external key identification device to the smart phone or tablet, insert the key into the external key identification device, start the application on the device and then take an image of the key to be associated with a unique key name. A subsequent insertion of a previously entered key will result in the display of the previously saved name of the key.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a perspective view of a first embodiment of the key identification device according to present invention.

FIG. 2 is a perspective view of a second embodiment of the key identification device according to present invention.

FIG. 3 is a top view of a third embodiment of the key identification device according to present invention.

FIG. 4 is a top view of a fourth embodiment of the key identification device according to the present invention.

### DETAILED DESCRIPTION OF THE INVENTION

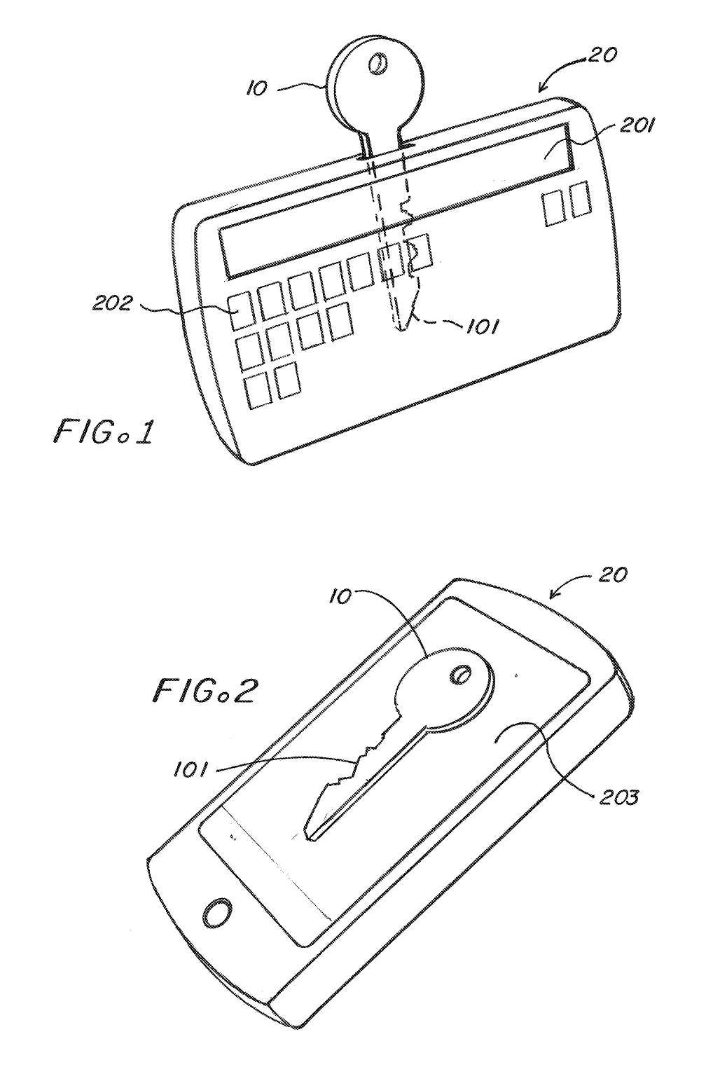

Referring now to FIG. 1 of the key identification tool generally referred to as 20. There is shown a key 10, key bittings 101, a display screen 201, and a keypad 202. This device additionally includes a key receipt aperture, a memory storage component, a processor, a power source, and electrical circuitry to operate and control the device. To use this device a user will insert a key 10 into the key receipt aperture. If the key 10 has not yet been assigned a name, the user will indentify the key. This is done by the user uniquely indentifying the key with a name and typing this name into the device 20 using the keypad 202. The display screen 201 will display the typed name. The device 20 will then read the bittings 101 of the key 10 and store the profile of the bittings 101 with the unique name of the key 10. The bittings 101 defining the geometry of the teeth of the key used to open a lock. The bittings 101 may be analyzed by any means that will allow an accurate reading of the individual characteristics of the key 10. This means may be a scanned image, a physical touching of the bittings and recording the profile, a photo, a light source generating a shadow that is then recorded, or any other similar means now known or hereafter known. After the key 10 is identified and assigned a unique name, later insertion of the key 10 into the device 20 will result in the display of the previously entered key name on the display screen 201 of the device 20.

Referring now to FIG. 2 a perspective view of the second embodiment of the key identification device. There is shown a smart phone, tablet, or other similar touch screen device generally referred to as 20, a key 10, key bittings 101, and a touch screen 203. According to this embodiment, an application is installed onto the smart phone, tablet device, or other similar device 20. This application will use the existing electronics of the smart phone device 20 to read the key bittings 101 and associate the unique key bittings 101 with a user entered name. Accordingly, a user will place the key 10 flat on the touch screen 203 of the smart phone or tablet device 20. The smart phone or tablet 20 will analyze the image of the key 10 with a particular emphasis on the unique bittings 101 and shape of the key. This image will then be stored. The user will then associate a name with this image which is also stored. For later identification, a key 10 that has been previously imaged will display the name associated with the stored image.

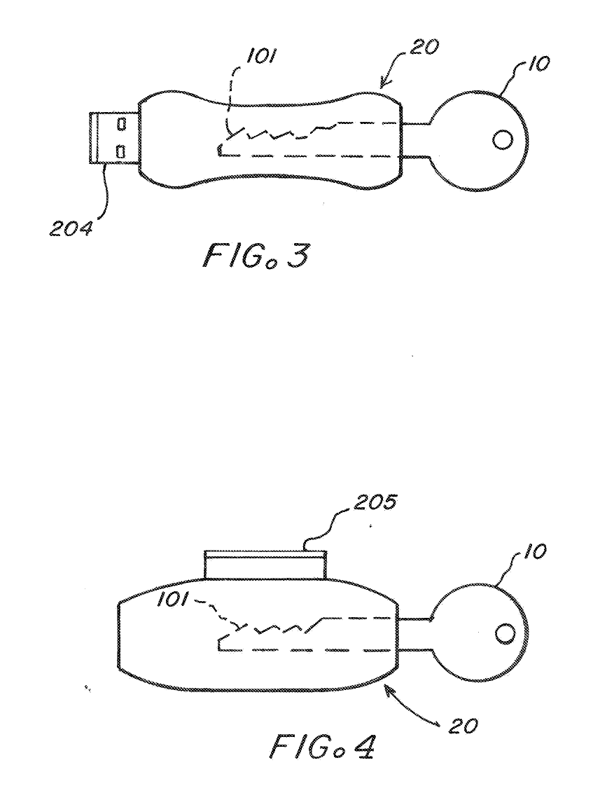

Referring now to FIG. 3 a top view of the third embodiment of the key identification device, there is shown a USB style device 20, a key 10, key bittings 101, and USB end 204. This device 20 is used to keep track of keys on a computer or other similar device by using the Universal Serial Bus (USB) port. The USB device 20 will include a means to measure or image the unique key bittings 101 of the inserted key 10. The computer or device containing the USB port will include software to capture the unique image of the key bittings 101. This image will then be stored. The user will then associate the stored image of the key 10 with a unique name. This name can then be retrieved when the key 10 is re-inserted into the device and recognized by the software.

Referring now to FIG. 4 a top view of the fourth embodiment of the key identification device, there is shown an external key identification device 20, a key 10, key bittings 101, and an adaptor 205. This external key identification device 20 will attach to and communicate with a smart phone or other similar device through an accessory port 205. This external key identification device 20 may be configured to work with several popular styles of smart phones and tablets. These smart phones or tablets will contain an application to control the external key identification device 20 and allow an image of the key 10 and the unique key bittings 101 to be stored on the device and associated with a unique name for the key 10. In use, a user will attach the external key identification device 20 to the smart phone or tablet, insert the key 10 into the external key identification device 20, start the application on the device and then take an image of the key 10 to be associated with a unique key name. A subsequent insertion of a previously entered key 10 will result in the display of the previously saved name of the key.

Referring now to FIGS. 1-4, a method of storing and retrieving the unique properties of a key is disclosed. According to this method, a user will insert a key 10 into a key identification device 20. This device can be a standalone device, an accessory to an existing device, or utilize the capabilities of an existing device. Software or an application on the device or on the parent device, if the device is an accessory device, will allow the user to associate the unique identification characteristics of a key 10 with a unique name and store this key 10 and name combination.

The device 20 will analyze the uniqueness of the key 10 by examining the key bittings 101. This examination may be a scanned image of the key 10, a photograph of the key 10, a physical measurement of the key 10, or any similar means to allow for the storage of the unique properties of the key 10. This analysis of the key 10 will then be stored on the device 20 or on the parent device, if the device 20 is connected to an additional device. The user will then name the key analyzed to be stored with the unique identification properties of the key 10. This allows a user to later identify a key that has an unknown use. To identify a key, a user will insert or place the key 10 into the device 20. The key 10 will be analyzed, and if the key has been previously identified the name associated with the key identification will be displayed allowing the user to recall the location of the lock or device the key 10 is used for.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment(s) but that the invention will include all embodiments falling with the scope of the appended claims.

What is claimed is:

1. A key identification device, the device comprising, in combination:
a. a key, the key having bittings, the bittings corresponding to a lock;
b. a means to capture the bittings of the key;
c. a means to read the bittings of the key;
d. a means to store the bittings of the key;
e. an input means to associate the stored bittings with a key name; and
f. a means to retrieve the key name associated with the stored bittings of the key.

2. The device of claim 1, wherein the capture means is a camera.

3. The device of claim 2, wherein the means to read the bittings, the means to store the bittings, and the input means is a software application present on a portable electronic device.

4. A key identification device, the key identification device located within a peripheral device in communication with a portable electronic device, the peripheral device comprising in combination:
a. a key, the key having bittings, the bittings corresponding to a lock;
b. an aperture, the aperture sized to receive the key;
c. a means to capture the bittings of the key;
d. a means to read the bittings of the key;
e. a means to store the bittings of the key;
f. an input means to associate the stored bittings with a key name; and
g. a means to retrieve the key name associated with the stored bittings of the key.

5. The device of claim 4, wherein device is connected to the portable electronic device using a USB port.

6. The device of claim 4, wherein the device is connected to the portable electronic device utilizing an accessory port.

7. A method for storing and retrieving the unique properties of a key, the key having bittings, the bittings used to open a lock, the method comprising:
a. using a capture means to capture the bittings of the key;
b. storing the captured bittings;
c. naming the stored and captured bittings associated with a given key;
d. recapturing the key to retrieve the name of the key.

8. The method of claim 7, wherein the capture means is a camera located on a portable electronic device and the method is a software application located on the portable electronic device.

9. The method of claim 7, wherein the device is a peripheral device in communication with a portable electronic device, the peripheral device having an aperture sized to receive the key.
